(19) United States
(12) Patent Application Publication
(10) Pub. No.: US 2011/0062239 A1
(43) Pub. Date: Mar. 17, 2011

(54) ELECTRONIC PAYMENT CARD MANUFACTURING PROCESS

(76) Inventors: Rachel Lau, San Jose, CA (US); Paul Tsao, Los Altos, CA (US); Kerry Brown, Portola Valley, CA (US)

(21) Appl. No.: 12/558,505

(22) Filed: Sep. 12, 2009

(51) Int. Cl. G06K 19/06

(52) U.S. Cl. 235/492; 257/679; 235/488; 361/737

(57) ABSTRACT

A payment card manufacturing process for a magnetic device (QChip) with a bit coil array to individually write several dynamic magnetic data bits into the magnetic material. The magnetic device fits inside the payment card's magnetic strip and contributes to the data recorded statically in the magnetic stripe. The magnetic device edges physically nearest the leading and trailing dynamic magnetic data bits are trimmed very closely and precisely by scoring the tops with deep reactive ion etching to produce deep trenches, and then back-grinding up from underneath to the trench bottoms. The magnetic device is inserted into a high precision die or laser cut opening in the magnetic stripe in each payment card. The locations of the static magnetic bits in the magnetic stripe are precisely recorded maintaining continuous signal integrity and integration during card personalization after electronically sensing the X,Y locations of the magnetic device's dynamic magnetic data bits.

### BACKGROUND OF THE INVENTION

1. Field of the Invention

The present invention relates to magnetic data card manufacturing, and in particular to devices and methods for fabricating payments cards with magnetic stripes that can autonomously reprogram some of the magnetic data bits recorded.

2. Description of Related Art

Common everyday use credit cards, debit cards, and access cards, are all now including electronics and batteries to support security and anti-fraud functions. The electronics and batteries integrated inside are up-to the challenges of years of service in the pockets and purses of their users, but the high heats and pressures briefly reached in mass producing plastics can be too much.

So instead of conventional high temperature, high pressure lamination processes, these electronic payment cards are made with reaction injection molded (RIM) methods that limit the temperatures and pressures suffered by the electronics embedded in the payment cards. The two-part plastics encapsulate the components and integrates everything together when the mixture cures.

The familiar magnetic stripes on the backs of credit cards and debit cards is ordinarily recorded once by the manufacturer and provided to the consumers as a fixed, static, permanent data recording. Such recording includes the users' identification and account numbers, and therein lies the problem. QSecure (Los Altos, Calif.) embeds an electronic device, the QChip or QStrip, within the magnetic data stripe of payment cards so that critical bits of the user account number and/or identification are dynamic and not fixed. These can produce use-once account numbers, and simple copying of the payment card's magnetic data will not enable a clone to be used in fraudulent transactions.

The dynamic magnetic data bits of the QChip or QStrip, and the static magnetic data bits in the surrounding magnetic stripe, must be seamlessly meshed together. Gaps in the magnetic recording as the reader transitions along between the magnetic stripe to the QChip and back must be kept to insignificant levels. This requires new methods of manufacturing and device technology that are answered by the embodiments of the present invention.

### SUMMARY OF THE INVENTION

Briefly, a magnetic device (QChip) embodiment of the present invention comprises an array of bit striplines with relatively low coercivity magnetic material. The bit striplines are able to produce magnetic fields sufficient to individually write several dynamic magnetic data bits into the magnetic material. The device edges physically nearest the leading and trailing dynamic magnetic data bits are trimmed very closely and precisely by scoring the tops by reactive ion etching to produce deep trenches, and then back-grinding up from underneath to the trench bottoms. After being fabricated, each magnetic device can be connected to an application specific integrated circuit (ASIC) either by way of chip-on-chip or chip-on-flexible substrate using a variety of readily available bonding techniques. After attaching a battery to the flex subassembly, the magnetic device can then be inserted into a high precision die or laser cut opening in the magnetic stripe in a payment card. The locations of the static magnetic bits in the magnetic stripe are recorded during card personalization after electronically sensing the exact position of the magnetic device's dynamic magnetic data bits.

An advantage of the present invention is that a manufacturing process is provided for a payment card that has a magnetic device in its magnetic stripe to make that portion of the recorded magnetic data reprogrammable by the internal electronics.

The above and still further objects, features, and advantages of the present invention will become apparent upon consideration of the following detailed description of specific embodiments thereof, especially when taken in conjunction with the accompanying drawings.

### BRIEF DESCRIPTION OF THE DRAWINGS

FIG. 1 is a perspective diagram of a flexible-circuit sub-assembly (FSA) embodiment of the present invention which joins a battery, a flex circuit, an ASIC chip, discretes, and a QChip magnetic device;

FIGS. 2A and 2B are perspective diagrams of the flexible-circuit sub-assembly (FSA) of FIG. 1 shown in relation to the back and front of a payment card in which they are embedded;

FIG. 3A is a cut away diagram of a payment card without its reverse side lamination, and representing a flexible circuit sub-assembly with a digital display, a Qbutton switch embedded in the plastic, and a QChip positioned for a die or laser cut window provided for it in the magnetic stripe. A pair of swipe contacts resembling rivets are seen here at one end of the magnetic stripe to detect a card-present use with a merchant card reader;

FIG. 3B is a cut away diagram of the payment card of FIG. 3A without its front side lamination, and showing the flexible circuit sub-assembly with its front facing digital display and Qbutton switch;

FIG. 3C is a reverse side view diagram of the payment card of FIGS. 3A-3B, and shows the final appearance of the QChip flush and square in its die or laser-cut window in the magnetic stripe;

FIG. 3D is a reverse side view diagram of the payment card of FIGS. 3A-3C, and shows the final appearance of the digital display and the Qbutton used to activate the card for each card-not-present transaction;

FIGS. 4A and 4B are flow charts of the assembly lines and processes used in manufacturing payment cards in an embodiment of the present invention that can be used to fabricate the payment cards and devices illustrated in FIGS. 1, 2A-2B, and 3A-3D;

FIG. 5 represents a fabrication process for manufacturing payment cards with QChips or QStrips;

FIGS. 6A-6C are plan, longitudinal cross-section, and lateral cross-section diagrams of a QChip that has been fabricated with thin film deposition technologies on a silicon or polymer substrate;

FIG. 7 is an exploded assembly diagram of a flexible circuit assembly showing how stiffeners can be used protect the circuit connection joints;

FIGS. 8A-8C are perspective view diagrams showing in stages how a chip die is singulated with DRIE so that its active area will approach 100% of the die area on the top of the chip die;

FIGS. 9A and 9B, are perspective view diagrams showing an otherwise conventional hot stamp machine modified to include a pressure pad resilient enough to distribute forces across an entire signature panel area; and

FIGS. 10A-10H and 10J-10K are cross sectional diagrams showing in wafer processing and chip stacking stages how a payment card is built with a 3D QChip-ASIC chip stack (FIG. 10K) has been connected with solder balls to a flex circuit assembly.

### DETAILED DESCRIPTION OF THE INVENTION

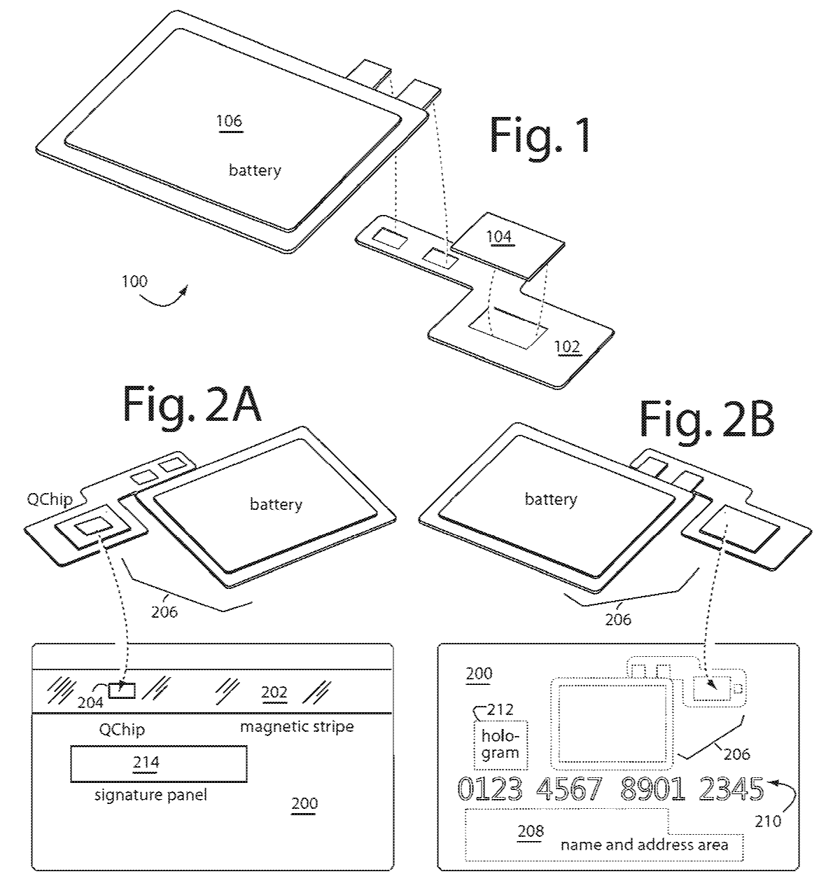

FIG. 1 represents a flexible-circuit sub-assembly (FSA) embodiment of the present invention, and is referred to herein by the general reference numeral 100. Such FSA 100 is particularly useful if installed in a magnetic-stripe type payment card. FSA 100 includes a printed flexible circuit 102 to which is mounted a an ASIC chip and QChip magnetic device 104, and a flat, flexible battery 106. The whole is thin enough to be embedded in a standard credit card, or other similar plastic payment card. A bit stripline array, on what will be the working, exposed side of the QChip magnetic device 104, is able to produce magnetic fields sufficient to write the dynamic magnetic data in such low coercivity material throughout an active area. The bit stripline is built up from many parallel sections of conductor all switched by a distributor. The current pulses through each stripline conductor section produce magnetic writing pulses to the adjacent low coercivity material. Thus new data can be written to the dynamic magnetic data. An external reader will thereafter be able to read out a hybrid combination of the dynamic magnetic data and static magnetic data in a magnetic stripe.

FIGS. 2A-2B represent a payment card 200 that has a conventional appearing magnetic stripe 202. A QChip magnetic device 204 is strategically positioned flush and square with the magnetic stripe 202 and connects to an electronics sub-assembly 206 embedded within. A name-and-address embossing area 208, account number 210, a hologram stamp 212, and signature panel 214, are placed outside the X,Y boundaries of the electronics sub-assembly 206 embedded within. The embossing and stamping follow the embedding of the electronics sub-assembly 206, and their pressings in later manufacturing steps could otherwise damage the electronics if their relative positions were not restricted.

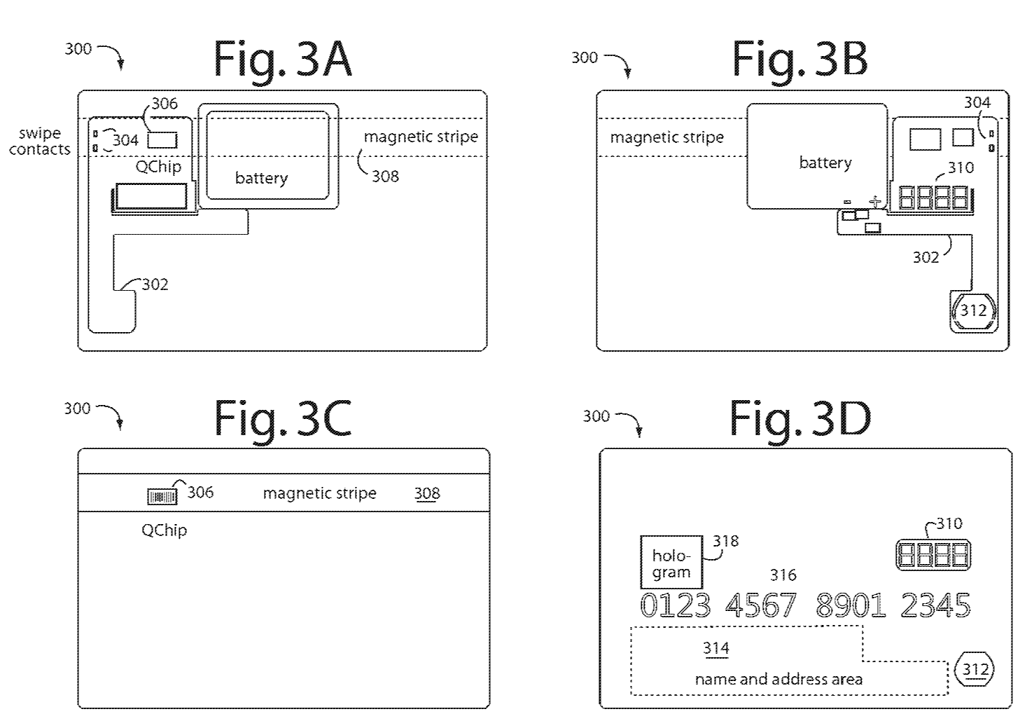

FIGS. 3A-3D represent a payment card 300 which is a variation of that shown in FIGS. 2A-2B. Payment card 300 supports card-not-present transactions by visually displaying a dynamic code or card value number when requested by the user's pressing a “Qbutton” switch if the customer desires in lieu of automatic sequencing via internal microcontroller time clock or swipe sensor when typically used with a always-on display such as electrophoretic type displays. For instance, payment card 300 has an electronics sub-assembly 302 that includes merchant card reader swipe card contacts 304 next to a QChip magnetic device 306 which insert into a magnetic stripe 308. A digital display 310, here shown in an example with four digits, produces a visual readout for a user when they press a Qbutton 312. A name-and-address embossing area 314, account number 316, and hologram stamp 318 are placed outside the X,Y boundaries of the electronics sub-assembly 302 embedded within.

A manufacturing process embodiment of the present invention, herein referred to by the general reference numeral 400, is used to manufacture the sub-assemblies, and fully finished payment cards illustrated in FIGS. 1, 2A-2B, and 3A-3D. Several feeder lines include flex-circuit 401, discrete components 402, microprocessor 403, ASIC 404, QChip 405, QStrip 406, display 407, switch 408, battery 409, back prelaminate 410, front prelaminate 411, and polyurethane (PU) 412. The result is individual payment cards feed out 413.

Discrete components from feeder 402 are soldered to flex-circuits from feeder 401 in a soldering step 420. Microprocessor feeder 403 passes to step 424 for topside under-bump metallization (UBM) and bumping, step 426 for dicing, and step 429 for pick and flip. UBM, for most applications, is the first step in bumping the integrated circuit (IC) bond pad and is critical to the overall success of the bump process. The main functions of a UBM stack include an adhesion layer with a low contact resistance between metal pads; a barrier layer to prevent the diffusion between the various bonding metals. A step 430 uses anisotropic conductive film (ACF) with thermo-compression (TC) bonding methods to bond the microprocessors to the flex-circuits. Alternative methods use anisotropic conductive paste (ACP), normal solder methods, and typical thermosonic bonding methods.

Application specific integrated circuits (ASIC's) from feeder 404 are similarly treated, step 432 provides for topside UBM and bumping, step 434 for dicing, and step 436 for pick and flip. A step 438 uses ACF or TC bonding methods to bond the ASIC's to the flex-circuits.

The details of the QChip referred to herein are described in U.S. patent application Ser. No. 11/479,897, filed Jun. 30, 2006, and titled, Q-CHIP MEMS MAGNETIC DEVICE. Such is incorporated herein by reference in full.

QChip magnetic devices in feeder 405 are given through-chip vias in step 440. Such through-chip vias enables backside connection either by chip stacking or chip to flex bonding and avoids exposing wire or other interconnects to the active side of the QChip that wears against merchant card readers in ordinary use over the service life. A step 442 builds up the magnetic device. A step 444 uses deep reactive-ion etching (DRIE) to create deep, steep-sided trenches laterally across the leading and trailing edges of the active magnetic bits on the QChips. A step 446 backgrinds the QChip, and chemical mechanical planarization (CMP) is used to smooth out the grinding. A step 448 provides for bottom passivation. A step 450 provides top UBM and bumping. A step 451 bottom-saws the devices up to the respective DRIE trenches to complete singulation of chips with the precision edges needed for seamless magnetic bit gaps to mate with, e.g., the magnetic stripe 308 (FIGS. 3A-3D).

The details of the QStrip referred to herein are described in U.S. patent application Ser. No. 11/955,365, filed Dec. 12, 2007, and titled, STRIPLINE MAGNETIC WRITING OF DYNAMIC MAGNETIC DATA BITS IN SURROUNDING REGIONS OF STATIC MAGNETIC DATA BITS. Such is incorporated herein by reference in full.

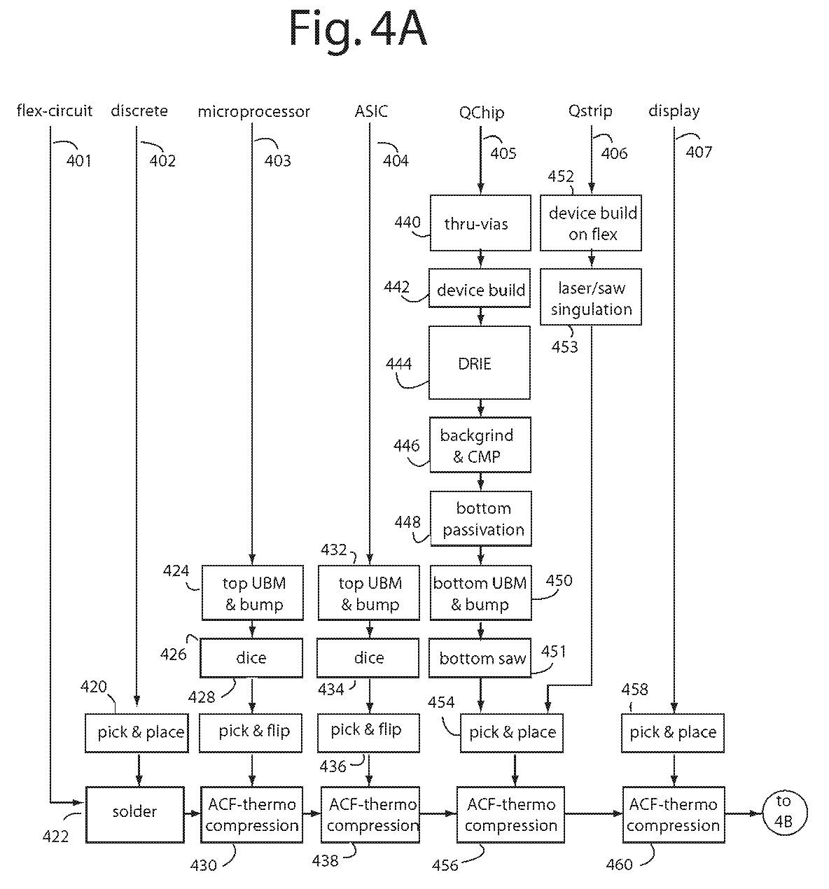

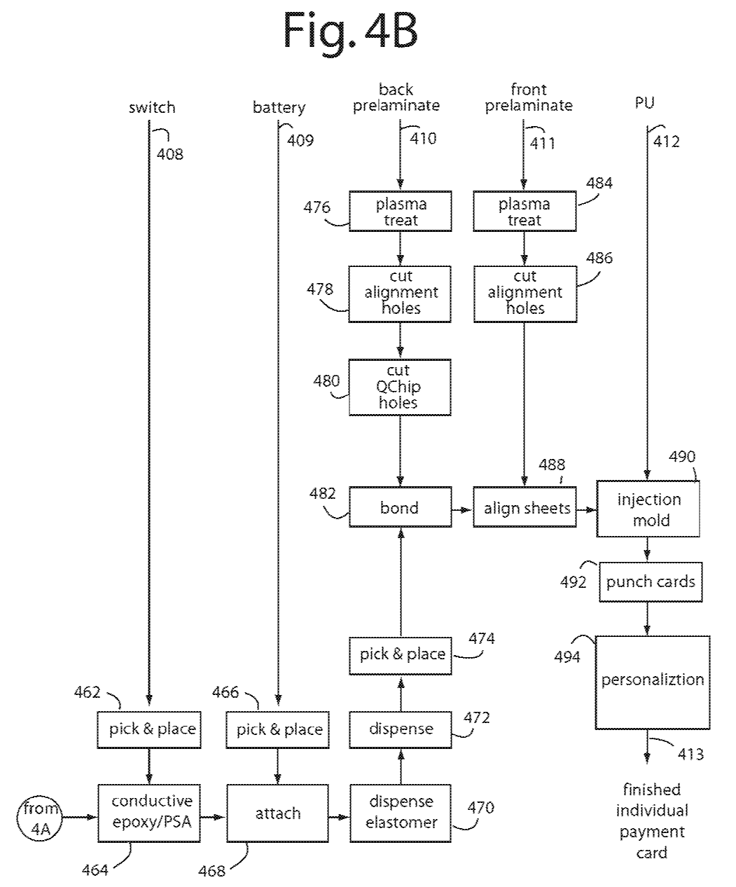

QStrip feeder 406 begins with a step 452 to put the device build on flex. A step 453 singulates by laser or sawing. A step 454 uses pick and place for a step 456 that uses ACF TC bonding methods to bond the QChip or Qstrip to the flex-circuits. The display feeder 407 passes to a step 458 for pick and place, and a step 460 that uses ACF TC bonding methods to bond the digital display to the flex-circuits. The switch feeder 408 (FIG. 4B) passes to a step 462 for pick and place, and a step 464 that uses ACF TC bonding or pressure sensitive adhesive (PSA) methods to bond the Qbutton switch to the flex-circuits. The battery feeder 409 passes the batteries to a step 466 for pick and place, and a step 468 uses soldering, AC TC, ultrasonic methods to bond the batteries to the flex-circuits. A step 472 dispenses elastomers, and a step 472 dispenses adhesives for a pick and place step 474.

The details of the front and back prelaminates, and of injection molding referred to herein, are all described in U.S. patent application Ser. No. 11/871,797, filed Oct. 12, 2007, and titled, PAYMENT CARD MANUFACTURING TECHNOLOGY. Such is incorporated herein by reference in full.

The back prelaminate feeder 410 begins with a plasma treating step 476 that prepares the surfaces to better adhere to the injection plastics and glues. A step 478 cuts the alignment pin holes in the prelaminate sheets. A step 480 cuts the rectangular holes in the magnetic stripe areas for the QChips. A step 482 bonds these to the flex-circuit subassemblies.

The front prelaminate feeder 411 begins with a plasma treating step 484 that prepares the surfaces to better adhere to the injection plastics and glues. A step 486 cuts the alignment pin holes in the prelaminate sheets so the back and front will align properly in a step 488. A step 490 injection molds the polyurethane in feeder 412. A step 492 punches or otherwise singulates the payment cards, and a step 494 personalizes them with account numbers, names, etc.

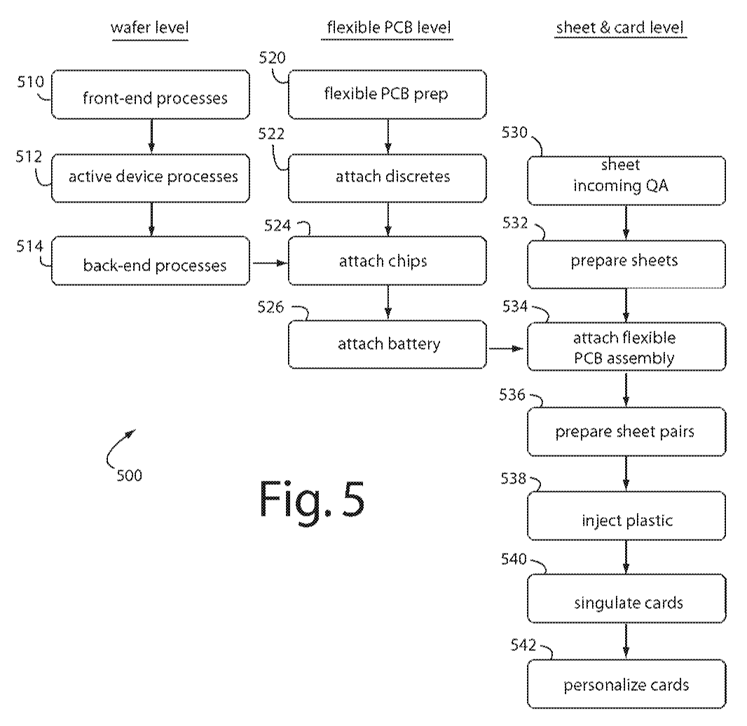

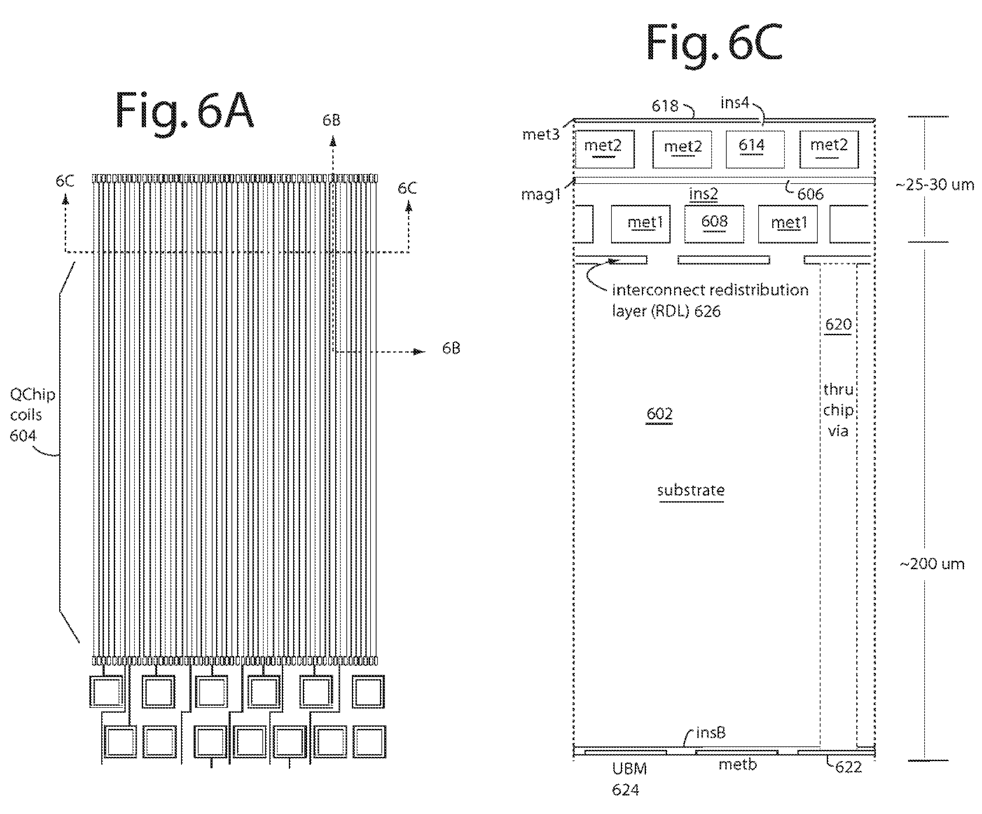

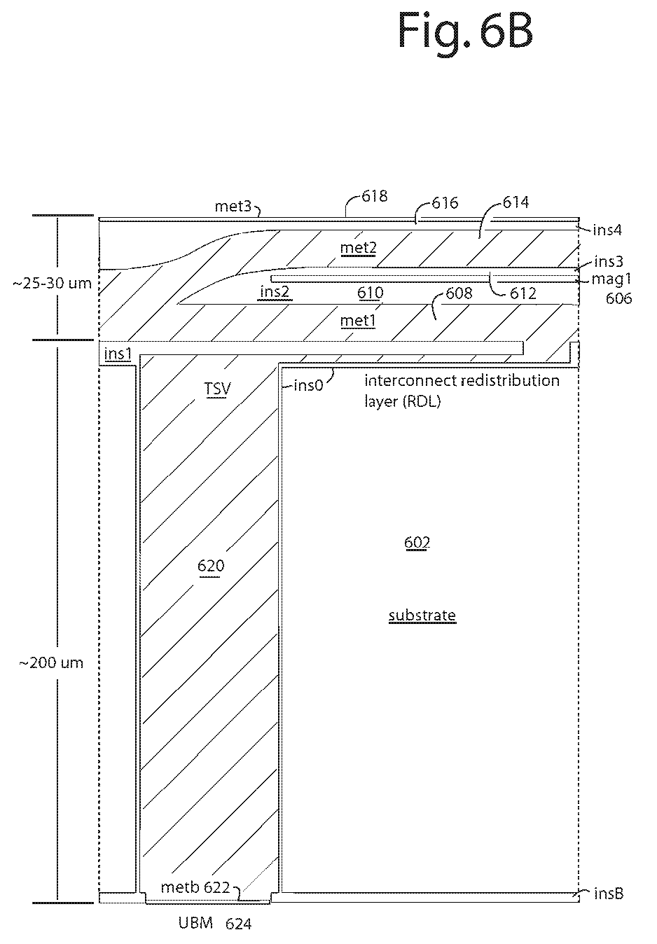

FIG. 5 represents a process 500 for manufacturing payment cards with QChips or QStrips. Process 500 begins at a wafer level with a front-end process 510 that includes z-axis interconnects through the magnetic device to the associated ASIC or flexible circuit. The details of the z-axis interconnects are provided in connection with FIG. 6. The wafer level continues with active device processes 512 and back-end processes 514.

The back-end processes 514 include die definition using DRIE, back grinding, CMP, saw or laser singulation, solder balls, gold or nickel plated bumps, gold studs, and chip stack technologies.

A flexible PCB level begins with a flexible PCB preparation 520, attaching discrete electronic components 522, attaching chips in step 524 provided from step 514, and attaching the battery 526.

Chip attach step 524 includes local solder reflow, thermocompression, thermosonic, and/or wire bonding the circuit connections. The battery attach step 526 uses ultrasonic welding, conductive epoxy, thermocompression, and/or soldering.

A sheet and card level for process 500 begins with incoming prelaminate sheet inspection and quality assurance step 530, preparation of the sheets step 532, a step 534 for attaching the flexible PCB assembly from step 526, a step 536 for preparing the sheet pairs, a step 538 for injecting the plastic, a step 540 for singulating the cards, and a step 542 for personalizing the cards.

The incoming prelaminate sheet inspection and quality assurance step 530 looks at the surface roughness, thickness, plastic vendor, and other properties. The sheet preparation 532 die or laser cuts or laser cuts the holes, and prepares the surface, e.g., with plasma treatments. Step 534 for attaching the flexible PCB assembly includes elastomer and adhesive dispensing, and adhesive stenciling.

FIGS. 6A-6C represent a QChip 600 that has been fabricated with thin film deposition technologies on a silicon or polymer substrate 602. The dimensions mentioned here and shown in the drawings are merely examples of some prototype embodiments that were made and tested. Non-silicon substrates are preferred for very high volume mass production because silicon foundries would be too limited to produce billions of QChips economically. The dimensions given in the illustrations are merely examples of what is possible.

As seen best in FIG. 6B, coils 604 are essentially wound around a magnetic bar (mag1) 606. Each turn of the coil is comprised of a first metal deposition (met1) 608 on the bottom overlaid by a second and third insulator (ins2) 610 and (ins3) 612, and a second metal deposition (met2) 614. A fourth insulation later (ins4) 616 separates the swipe sensor switch contacts formed with a top most metal layer (met3) 618. Each magnetic bit position of coils 604 has an electrical tap that allows individual magnetic bits to be written. These are communicated down to the back face by through-silicon vias (TSV's) 620. A bottom metallization (metb) 622 provides for UBM contact 624. An interconnect redistribution layer (RDL) 626 provides for circuit routing between the TSV's 620 and first metal deposition (met1) 608.

The substrate 602 is typically two hundred microns (um) in vertical (z-axis) thickness, and coils 604 are 25-30 microns in vertical height.

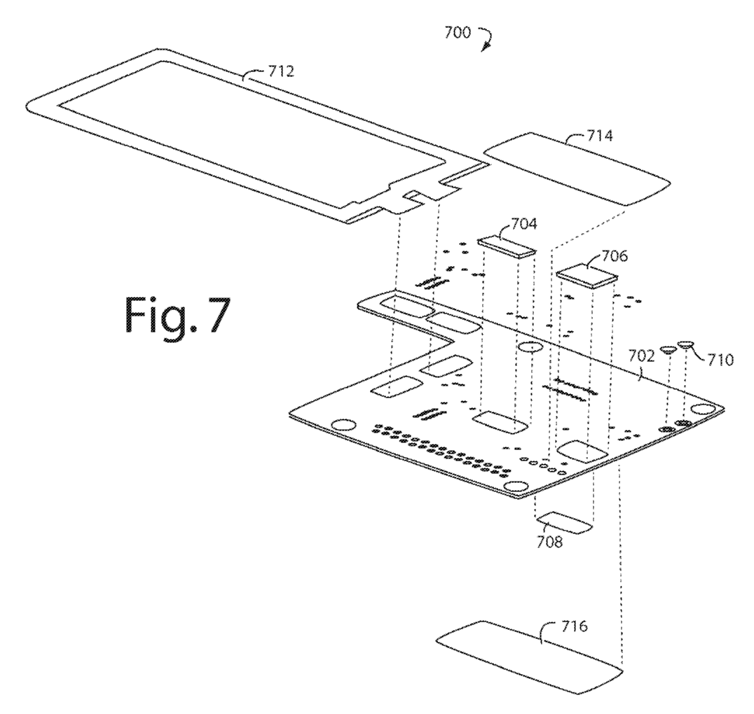

FIG. 7 represents how stiffeners can be used in a flexible circuit assembly 700. A flex circuit 702 has an ASIC 704, a microprocessor 706, a QChip 708, a pair of switch contact studs 710, and a battery 712 attached to it as described in FIGS. 4A, 4B, and 5. A few stiffeners 714 and 716 are glued on over the critical areas where the large chips attach to redirect stresses of payment card use away from the delicate electrical connections between the chips 704, 706, 708, and the flex circuit 702. The injection molding to complete the payment card follows this component assembly.

The switch contact studs 710 seen so well in FIG. 7 ultimately protrude through the payment card's magnetic stripe just ahead of the QChip and serve to electrically trigger the ASIC 704 when a financial transaction is begun with a merchant card reader.

Applications that require very high tolerance die singulation cannot accommodate the wide tolerances associated with blade dicing or laser dicing. Here, die edge tolerances must be fifteen microns or less to minimize loss of magnetic information in the payment card's magnetic stripe and to maintain a seamless interface (buttability). The requirement can be met by defining the edge of a QChip or QStrip die using an optically precise, photolithographic-based definition technique. U.S. Pat. No. 7,335,576, issued Feb. 26, 2008, to David Ludwig, et al., is informative. Such describes two etching processes, reactive ion etching (RIE) and deep reactive ion etching (DRIE).

Reactive ion etching involves the conversion of an etch gas into a plasma. An electrode is used to accelerate the ions in such a manner as to etch a semiconductor substrate using chemical and physical reactions. Reactive ion etching exhibits some undesirable isotropic etching characteristics, e.g., vertical and lateral etching under a photomask. Making RIE not suitable where highly orthogonal sidewalls are desired. Deep reactive ion etching is a variant of RIE that permits very high aspect ratio features to be fabricated with substantially orthogonal sidewalls because it is an anisotropic process. DRIE is well-suited for bulk silicon etching, but not for etching through silicon oxide/dielectric features in the layers contained in integrated circuit die. Any anisotropic etching process capable of vertical sidewall etching in the substrate may be used in the present invention.

In embodiments of the present invention, two sided buttability is critical, but all four edges can be fabricated using DRIE to be highly orthogonal to one another and the rectangular hole cut for the QChip and QStrip in the back prelaminate sheets.

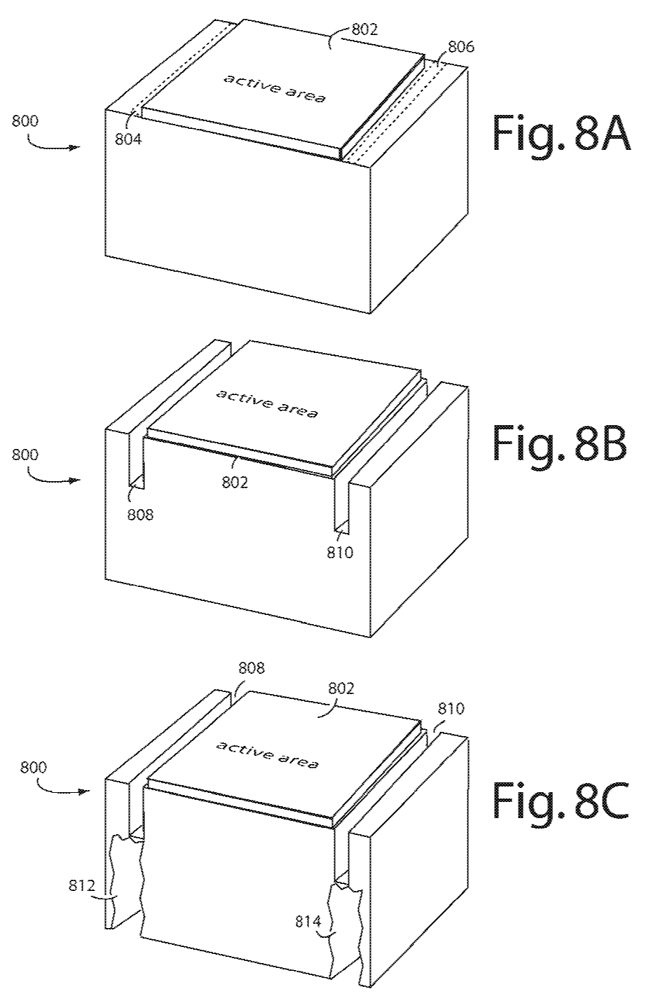

FIGS. 8A-8C represent how a chip die 800 is singulated so that its active area 802 will approach 100% of the top die surface area. DRIE singulation channels 804 and 806 are defined using optically precise photolithographic masking process generally available only at a semiconductor foundry level. Singulation channels 808 and 810 can be formed, e.g., using anisotropic DRIE to penetrate to a predefined depth of the bulk silicon. Non-precision back saw cuts 812 and 814 from beneath are used to complete the singulation process along die streets. Alternative embodiments of the present invention do not use silicon for the QChip and QStrip substrates. This is important in situations where the cost or volume limitations of fabricating in silicon are prohibitive.

Once a white card or blank payment card has been fabricated and is ready for personalization, conventional signature panel stamping systems may have problems with electronic type payment cards from the additional surface topography induced by the embedded items. Conventional signature panel stamping has been designed and built for very flat cards, and oven-cured high-pressure processes. A new method is needed to overcome a problem associated with stamping a signature panel onto a plastic payment card that may have slight topographical perturbations.

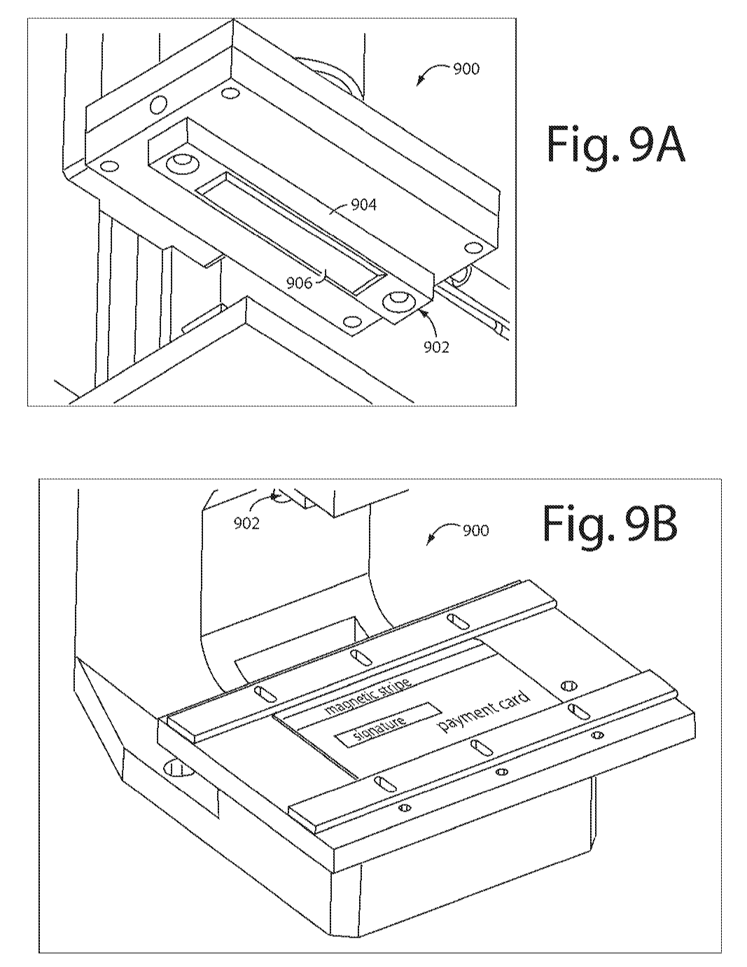

In FIG. 9, an otherwise conventional hot stamp machine 900 is modified to include a semi-compliant pressure pad 902 resilient enough to distribute forces across an entire signature panel area. This provides for the intimate contact needed between signature panel adhesives and the electronic payment cards. The effort needed for a typical retrofit is very minor, and a new semi-compliant pressure pad is simply mounted to the stamping tool.

Pressure pad 902 would be appropriately sized for the signature panel and be mounted onto an aluminum screw-on base 904. A silicone rubber slab 906 or other hi-temp rubber compound with an 80-Shore-A resilience, for example, is bonded to the face. For example, slab 906 can be comprised of a styrene-butadiene copolymer like Total Petrochemicals' Finaprene® 411x, or other thermoplastic elastomer type radial styrene-butadiene block copolymer. The edges of the resilient rubber slab 906 are chamfered at 45-degrees all around the edges to the base.

Devices based on 3D chip stacking and integration can significantly outperform traditional planar (2D) devices. Cost reductions and fits within confined spaces are possible by integrating multiple functional entities in one package. Stacking of individual chips, both chip-to-wafer and wafer-to-wafer, has the inherent advantage that different functional subsystems like logic and memory can be processed on separate wafers thereby greatly reducing the complexity and the number of process steps. Individual chips, like ASIC's, microprocessors, and QChips, can be processed on different substrates with different technologies, in different fabs, and by different producers. Wafer-level integration has the advantage of higher throughput and enhanced cleanliness. Standard fab equipment can be used for further processing. 3D integration and chip-to-wafer bonding can be used to stack dies of different sizes, e.g. several small dies on one big base die.

Manufacturing embodiments of the present invention can employ chip to chip and chip to wafer techniques in which 3D stacking mounts an ASIC underneath of a QChip or QStrip with interconnects made by through silicon vias (TSV's) or conventional drill and plate vias. A hybridization method embodiment of the present invention puts the active area of a QChip into the static area of a payment card magnetic stripe. Alternative manufacturing embodiments of the present invention when combined with the prior reference to the Stripline Patent filing will use through-polymer vias, or conventional drill and plate vias.

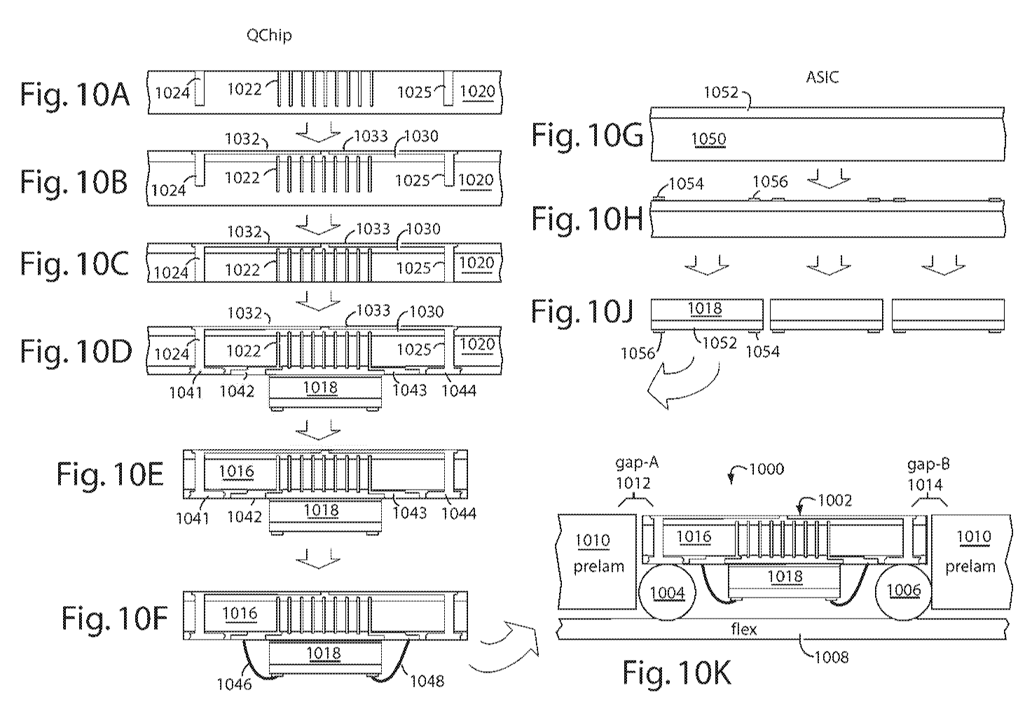

FIGS. 10A-10H and 10J-10K show a portion of a payment card 1000 in which a 3D QChip-ASIC chip stack 1002 (FIG. 10K) has been connected with solder balls 1004 and 1006 to a flex circuit assembly 1008. The 3D QChip-ASIC chip stack 1002 has a larger top portion that has been singulated so precisely it fits within a rectangular opening in a prelaminate sheet 1010 with longitudinal gaps (A and B) 1012 and 1014 that do not exceed fifteen microns. Here in this example, the larger top portion is a QChip 1016 with an ASIC 1018 underneath. The build-up of 3D QChip-ASIC chip stack 1002 with solder balls 1004 and 1006 on flex circuit assembly 1008 is tightly controlled during assembly to maintain a flush finish between the exposed top surfaces of QChip 1016 and prelaminate 1010 with its magnetic stripe.

The chip to wafer techniques of FIGS. 10A-10H and 10J-10K start with FIG. 10A in the fabrication of the QChip 1016. A substrate 1020 receives many TSV's 1022, 1024, and 1025, for interconnects down through to the ASIC 1018 and flex circuit 1008. In FIG. 10B, an active area 1030 is fabricated with swipe sensor switch contact films 1032 and 1033 on top. In FIG. 10C, back grinding and CMP have planarized the bottom of substrate 1020 and prepared it for the backside processes. In FIG. 10D, backside processes have fabricated a redistribution layer to complete the interconnects between the TSV's 1022, 1024, and 1025, with ASIC 1018 and pads 1041-1044. FIG. 10E shows QChip 1016 singulated and with ASIC 1018 attached. FIG. 10F shows a typical attachment method using conventional wire bonds 1046 and 1048.

FIG. 10G shows how the ASIC starts as a wafer 1050 with an active area 1052. In FIG. 10H, font side bumps 1054 and 1056 have been deposited, and wafer 1050 has been background and planarized with CMP. In FIG. 10J, ASIC 1018, and others, have been singulated from wafer 1050.

Although particular embodiments of the present invention have been described and illustrated, such are not intended to limit the invention. Modifications and changes will no doubt become apparent to those skilled in the art, and it was intended that the invention only be limited by the scope of the appended claims.

The invention is claimed, as follows.

1. A payment card manufacturing process, comprising:
trimming the edges of a magnetic device (QChip or QStrip) during device singulation so its leading and trailing dynamic magnetic data bit positions are adjacent to its leading and trailing finished edges;
disposing the magnetic device (QChip or QStrip) in an opening in a magnetic stripe of a payment card and flush; and
minimizing any magnetic recording gaps between said leading and trailing dynamic magnetic data bit positions and adjacent areas of said magnetic stripe;
wherein, a subsequent magnetic data recording which is a hybridization of dynamic magnetic data bits provided by the magnetic device (QChip or QStrip), and static magnetic data bit prerecorded earlier in the magnetic stripe, can be read without magnetic bit dropouts at the interface transitions.

2. The payment card manufacturing process of claim 1, wherein the trimming further comprises:
defining the edge of the magnetic device (QChip or QStrip) using an optically precise, photolithographic-based definition technique.

3. The payment card manufacturing process of claim 2, wherein the trimming further comprises:
sawing up from the back side of the magnetic device (QChip or QStrip) to said deep trench to complete singulation.

4. The payment card manufacturing process of claim 1, wherein the trimming further comprises:
reactive ion etching of a top side of the magnetic device (QChip) to produce a deep trench to precisely define said edges.

5. The payment card manufacturing process of claim 1, further comprising:
stamping a signature panel with adhesive backing onto the payment card using a press with a resilient pad of about 80-Shore-A;
wherein, non-planar surface irregularities of the payment card are accommodated.

6. The payment card manufacturing process of claim 1, further comprising:
chip stacking the magnetic device (QChip or QStrip) to an application specific integrated circuit (ASIC); and
interconnecting electrical circuits to the ASIC with through-silicon vias (TSV's).

7. The payment card manufacturing process of claim 1, further comprising:
assembling the magnetic device (QChip or QStrip) and an application specific integrated circuit (ASIC) to a flexible printed circuit;
interconnecting electrical circuits to the ASIC with through-silicon vias (TSV's).

8. The payment card manufacturing process of claim 1, further comprising:
recording magnetic bit locations in the magnetic stripe by first electronically sensing the X,Y locations of dynamic magnetic data bits of the magnetic device (QChip or QStrip).

9. A payment card manufacturing process, comprising:
defining the edges of a magnetic device (QChip or QStrip) using an optically precise, photolithographic-based definition technique;
trimming the edges of said magnetic device (QChip or QStrip) during device singulation so its leading and trailing dynamic magnetic data bit positions are adjacent to its leading and trailing finished edges;
sawing up from the back side of the magnetic device (QChip or QStrip) to said deep trench to complete singulation.
chip stacking the magnetic device (QChip or QStrip) to an application specific integrated circuit (ASIC);
interconnecting electrical circuits to the ASIC with through-silicon vias (TSV's);
assembling the magnetic device (QChip or QStrip) and an application specific integrated circuit (ASIC) to a flexible printed circuit;
positioning the magnetic device (QChip or QStrip) in an opening in a magnetic stripe of a payment card and flush;
minimizing any magnetic recording gaps between said leading and trailing dynamic magnetic data bit positions and adjacent areas of said magnetic stripe, wherein a subsequent magnetic data recording which is a hybridization of dynamic magnetic data bits provided by the magnetic device (QChip or QStrip), and static magnetic data bit prerecorded earlier in the magnetic stripe, can be read without magnetic bit dropouts at the interface transitions;
stamping a signature panel with adhesive backing onto the payment card using a press with a resilient pad of about 80-Shore-A, wherein non-planar surface irregularities of the payment card are accommodated; and
recording static magnetic bit locations in the magnetic stripe by first electronically sensing the X,Y locations of dynamic magnetic data bits of the magnetic device (QChip or QStrip).

10. A payment card product of the process of claim 9.
